(19) United States
(12) Patent Application Publication
(10) Pub. No.: US 2026/0223766 A1
(43) Pub. Date: Aug. 6, 2026

(54) SYSTEM AND METHOD FOR AUTOMATED TANK PRESSURE ADJUSTMENT

(71) Applicant: CNH Industrial Canada, Ltd., Saskatoon (CA)

(72) Inventors: Matthew James Stefaniuk, Saskatoon (CA); Anthony Albert Loeffen, Saskatoon (CA)

(21) Appl. No.: 19/045,481

(22) Filed: Feb. 4, 2025

(51) Int. Cl. A01C 7/20; A01C 7/10

(52) U.S. Cl. CPC A01C 7/205; A01C 7/105

(57) ABSTRACT

A control system for an agricultural seeding implement includes a controller including a memory and a processor. The controller is configured to iteratively determine a respective meter pressure for each meter of a plurality of meters, determine a respective storage tank pressure for each storage tank of a plurality of storage tanks, determine a respective current pressure differential for each storage tank of the plurality of storage tanks, compare the respective current pressure differential to a target pressure differential range, and adjust a respective pressure valve for each tank of the plurality of tanks. Additionally, in response to determining the respective current pressure differential for any storage tank of the plurality of storage tanks is less than the minimum pressure threshold while the respective pressure valve is fully open, the controller is configured to reduce the maximum pressure threshold.

### BACKGROUND

The present disclosure relates generally to a system and method for automated tank pressure adjustment.

Generally, agricultural seeding implements are towed behind a work vehicle, such as a tractor. The agricultural seeding implement may include multiple row units to excavate trenches into soil for depositing an agricultural product, such as seed or fertilizer. An air cart may be towed behind or in front of the agricultural seeding implement, in which the air cart is configured to provide the agricultural product to the row units. In this manner, rows of the agricultural product may be deposited into the soil.

The agricultural product may be pneumatically conveyed from the air cart to the row units via distribution lines (e.g., primary lines, secondary lines, tertiary lines, etc.). For example, the air cart may include an air source configured to output an air flow, and multiple primary lines may extend from the air source. A metering system positioned downstream from the air source may meter the agricultural product from storage tank(s) into the primary lines, and the air flow may fluidize and convey the agricultural product through each primary line to a respective header. The agricultural product may then flow from each header through multiple secondary lines toward respective row units. The storage tank(s) may be pressurized with air from the air source. The pressure in the storage tank(s) may assist the flow of agricultural product through the metering system. Unfortunately, during operation of the agricultural seeding implement, pressure within at least one storage tank may be outside of a threshold range, thereby reducing the accuracy of the metering system.

### BRIEF DESCRIPTION

In certain embodiments, a control system for an agricultural seeding implement including a controller including a memory and a processor. The controller is configured to iteratively determine a respective meter pressure for each meter of a plurality of meters. The controller is further configured to iteratively determine a respective tank pressure for each tank of a plurality of tanks. Each meter of the plurality of meters is configured to receive respective agricultural product from a respective tank of the plurality of tanks. The controller is configured to iteratively determine a respective current pressure differential for each storage tank of the plurality of tanks based on the respective meter pressure and the respective tank pressure. For each storage tank of the plurality of tanks, the controller is configured to iteratively compare the respective current pressure differential to a target pressure differential range. The target pressure differential range is based on a minimum pressure threshold and a maximum pressure threshold. The controller is configured to iteratively adjust a respective valve for each storage tank of the plurality of tanks based on the comparison of the respective current pressure differential to the target pressure differential range. Additionally, in response to determining the respective current pressure differential for any storage tank of the plurality of storage tanks is less than the minimum pressure threshold while the respective valve is fully open, the controller is configured to iteratively reduce the maximum pressure threshold.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having an agricultural seeding implement and an air cart;

FIG. 2 is a schematic diagram of an embodiment of an agricultural product distribution system that may be employed within the agricultural system of FIG. 1;

FIG. 3 is a schematic diagram of an embodiment of a tank pressure control system that may be employed within the agricultural product distribution system of FIG. 2;

FIG. 4 is a flow chart of an embodiment of a method of operation of a tank pressure control system.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

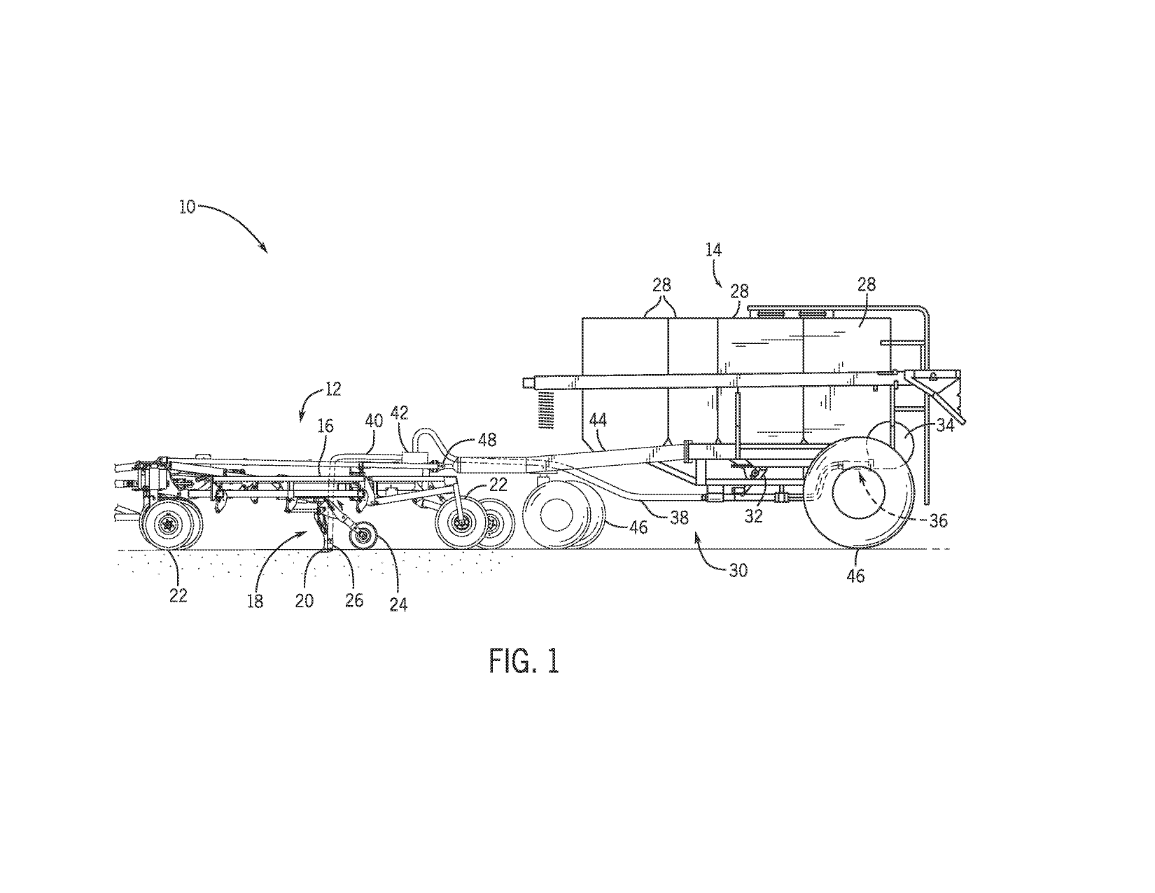

FIG. 1 is a side view of an embodiment of an agricultural system 10 having an agricultural seeding implement 12 and an air cart 14. In the illustrated embodiment, the agricultural seeding implement 12 includes a frame 16, and a row unit 18, which includes an opener 20, is coupled to the frame 16. As illustrated, wheel assemblies 22 are also coupled to the frame 16. The agricultural seeding implement 12 may be pulled through a field by a work vehicle (e.g., a tractor), and the agricultural seeding implement 12 may deposit rows of agricultural product (e.g., seed, fertilizer, inoculant, etc.) into the soil as the agricultural seeding implement 12 traverses the field. The wheel assemblies 22 contact the soil surface and enable the agricultural seeding implement 12 to be pulled by the work vehicle, and the row unit 18 may deposit one row of the agricultural product into the soil. Although only one row unit 18 is shown coupled to the frame 16 for clarity, the agricultural seeding implement 12 may include multiple row units 18 (e.g., organized in one or more rows across the agricultural seeding implement 12). In some embodiments, the agricultural seeding implement 12 may include 12, 14, 16, 18, 20, or more row units 18, each of which may deposit agricultural product into the soil to form a respective row.

To facilitate depositing the agricultural product within the soil, each row unit 18 includes the opener 20, a packer wheel 24, and a seed boot 26. In response to movement of the row unit 18 through the field, the opener 20 exerts a force onto the soil that excavates a trench within the soil. As the agricultural seeding implement 12 moves through the field, the row unit 18 may deposit the agricultural product into the excavated trench via the seed boot 26. Then, the packer wheel 24 may pack soil onto the deposited agricultural product.

In the illustrated embodiment, the air cart 14 includes multiple storage tanks 28 configured to centrally store the agricultural product. In addition, the agricultural system 10 includes distribution lines 30 configured to facilitate flow of the agricultural product to the row units 18. Furthermore, the air cart 14 includes a metering system 32 configured to control flow of the agricultural product into the distribution lines 30. The air cart 14 also includes an air source 34 configured to provide an air flow through the distribution lines 30. The air flow interacts with the agricultural product flowing into the distribution lines 30 from the metering system 32, thereby fluidizing the agricultural product and forming an air/agricultural product mixture. The distribution lines 30 are configured to transport the air/agricultural product mixture to the row units 18, thereby providing the row units 18 with a metered flow of the agricultural product.

In the illustrated embodiment, the air cart 14 includes a plenum 36 coupled to the air source 34. The plenum 36 is configured to distribute the air flow provided by the air source 34 across multiple primary lines 38 of the distribution lines 30. The metering system 32 controls the flow of the agricultural product into the primary lines 38, and the air flow through the primary lines 38 fluidizes the agricultural product and conveys the agricultural product toward the row units 18. In addition, the distribution lines 30 include secondary lines 40 coupled to each primary line 38 via a respective distribution header 42. Each distribution header 42 is configured to distribute the air/agricultural product mixture provided by a respective primary line 38 to multiple secondary lines 40. In the illustrated embodiment, each secondary line 40 is coupled to a respective row unit 18. Accordingly, the agricultural product is conveyed from one or more storage tanks 28 to the row units 18 via the primary lines 38, the distribution headers 42, and the secondary lines 40. However, in other embodiments, the agricultural system may include a secondary distribution header coupled to each secondary line, and multiple tertiary lines may be coupled to each secondary distribution header. In such embodiments, each tertiary line may be coupled to a respective row unit, such that the agricultural product is distributed via the primary lines, primary distribution headers, secondary lines, secondary distribution headers, and tertiary lines. Furthermore, in certain embodiments, the secondary lines and the distribution headers may be omitted, and the primary lines may be directly coupled to respective row units.

In the illustrated embodiment, the air cart 14 includes a frame 44 configured to support the storage tanks 28, the metering system 32, the air source 34, and the plenum 36. The air cart 14 also includes wheels 46 rotatably coupled to the frame 44 and configured to facilitate movement of the air cart 14 through the field. In the illustrated embodiment, the air cart 14 is towed behind the agricultural seeding implement 12. Accordingly, the agricultural seeding implement 12 is coupled to the work vehicle by a first hitch assembly, and the air cart 14 is coupled to the agricultural seeding implement 12 by a second hitch assembly 48. However, in other embodiments, the agricultural seeding implement may be towed behind the air cart. In further embodiments, the agricultural seeding implement and the air cart may be part of a single unit that is towed behind a work vehicle, or the agricultural seeding implement and the air cart may be elements of a self-propelled vehicle.

In certain embodiments, the air cart 14 of the agricultural system 10 may include a tank pressure control system for pressure control within the storage tanks 28 on the air cart 14. The tank pressure control system may manage the pressure in each storage tank 28 by increasing, decreasing, or maintaining the opening of a respective pressure valve attached to each storage tank 28. The tank pressure control system may control the pressure valves to substantially maintain a target pressure differential, corresponding to the difference in pressure between the storage tank and the respective meter of the metering system, for each storage tank. Sensors in the storage tanks and the meters may monitor the pressures in the storage tanks and the meters, and a controller of the tank pressure control system may determine the respective current pressure differential for each storage tank 28. The controller may control each pressure valve to increase opening, decrease opening, or maintain opening based on a comparison of the current pressure differential for the respective storage tank and a target pressure differential range. Further, if adjusting any respective pressure valve is insufficient for the pressure differential for the respective storage tank to reach the target pressure differential range, the controller of the tank pressure control system may decrease a maximum pressure threshold of the target pressure differential range until the pressure differential in the respective storage tank is within the new target pressure differential range. As such, the controller may control the pressure valves on the other storage tanks until the pressure differential for each of the other storage tanks is within the new target pressure differential range. The tank pressure control system may assist the metering system with producing a steady and accurate flow of agricultural product through the meters by maintaining a pressure differential that encourages flow through each meter without expelling the agricultural product at a higher than desired flow rate.

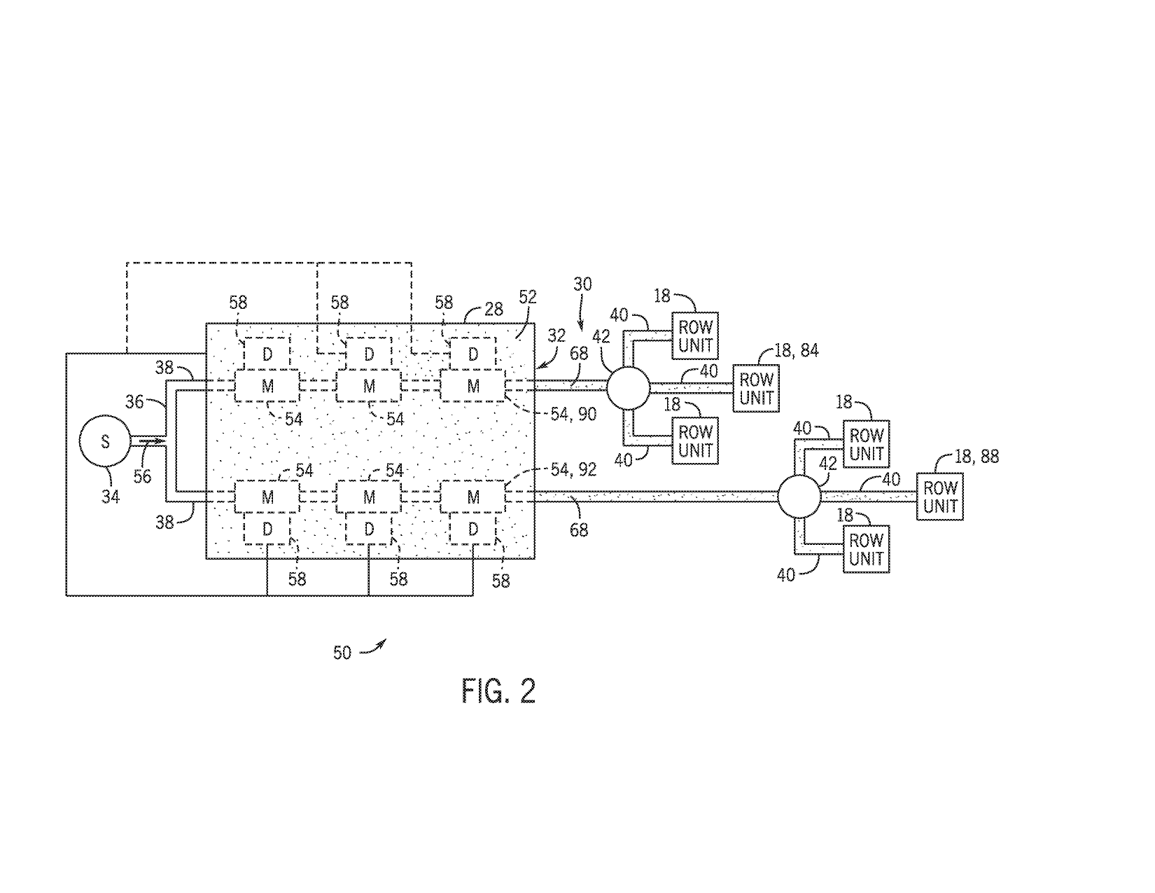

FIG. 2 is a schematic diagram of an embodiment of an agricultural product distribution system 50 that may be employed within the agricultural system of FIG. 1. The agricultural product distribution system 50 includes the air source 34, the plenum 36, the distribution lines 30, the distribution headers 42, the storage tanks 28, and the metering system 32. As previously discussed, the air source 34 is coupled to primary lines 38 of the distribution lines 30 via the plenum 36. The air source 34 may include fan(s), pump(s), blower(s), or a combination thereof, driven by suitable motor(s), such as electric motor(s), hydraulic motor(s), pneumatic motor(s), etc. Flowable agricultural product 52 (e.g., seed, fertilizer, etc.) within the storage tanks 28 flows under the influence of gravity into the metering system 32. The storage tanks 28 may be pressurized such that a static pressure in each storage tank 28 is greater than a static pressure in the metering system 32 (e.g., at the storage tank), thereby facilitating an even flow of the agricultural product through the metering system 32. In the illustrated embodiment, the metering system 32 includes two meters 54 (e.g., meter rollers) positioned below each storage tank 28 and configured to control the flow of the agricultural product 52 from the storage tank 28 into the air flow 56 output by the air source 34. Each meter 54 (e.g., meter roller) is housed within an individual meter box, and each meter 54 (e.g., meter roller) is configured to control flow of the agricultural product 52 into a respective primary line 38 for distribution to one or more respective row units of the agricultural seeding implement. By independently adjusting the rotation speed of each meter 54, flow of the particulate material to different portions of the agricultural seeding implement may be particularly controlled. While the metering system 32 includes two meters 54 per storage tank 28 (e.g., six total meters 54) in the illustrated embodiment, in other embodiments, the metering system may include more or fewer meters per storage tank (e.g., 1, 3, 4, 5, 6, 7, 8, 9, 10, 11, 12, 13, 14, or more).

In the illustrated embodiment, each meter 54 (e.g., meter roller) is coupled to a respective drive assembly 58 of the metering system 32, and each drive assembly 58 is configured to drive the respective meter 54 (e.g., meter roller) to rotate, thereby facilitating independent control of the rotation rates of the meters 54. Each drive assembly 58 includes at least one drive unit, such as an electric or hydraulic motor, configured to drive the respective meter 54 to rotate. While each meter 54 is independently driven to rotate by a respective drive assembly 58 in the illustrated embodiment, in other embodiments, a single drive assembly may be configured to drive all of the meters to rotate together. Furthermore, in certain embodiments, the drive assembly may be omitted, and the meters may be coupled to a wheel (e.g., via a gear assembly), such that rotation of the wheel drives the meters to rotate.

In certain embodiments, each meter includes a meter roller having multiple flutes and corresponding recesses, in which the flutes and corresponding recesses are configured to meter the flowable agricultural product via rotation of the meter roller. Each recess is disposed between a respective pair of flutes. As the meter roller rotates, the respective pair of flutes moves the flowable agricultural product disposed within the respective recess downwardly, thereby transferring the flowable agricultural product 52 to the respective primary line 38. The number and geometry of the flutes may be particularly configured to accommodate the agricultural product being distributed. Certain meter rollers may include six flutes and a corresponding number of recesses. Other meter rollers may include more or fewer flutes and/or recesses. For example, the meter roller may include 1, 2, 3, 4, 5, 6, 7, 8, 9, 10, 11, 12, 13, 14, 15, 16, 17, 18, 19, 20, or more flutes and/or recesses. In addition, the depth of the recesses and/or the height of the flutes may be configured to accommodate the agricultural product metered by the meter roller. For example, a meter roller having deeper recesses and fewer flutes may be employed for larger seeds, while a meter roller having shallower recesses and more flutes may be employed for smaller seeds. Other parameters, such as flute pitch (i.e., angle of the flute relative to a longitudinal/rotational axis of the meter roller) and flute angle (i.e., angle of the flute relative to a radial axis of the meter roller), may also be particularly selected to accommodate the flowable agricultural product. While meters including meter rollers are disclosed above, in certain embodiments, at least one meter (e.g., each meter) may include any other suitable device (e.g., auger) configured to control flow of the agricultural product via rotation of the meter.

For a particular meter configuration (e.g., meter roller profile), the rotation rate of the meter 54 (e.g., meter roller) controls the flow of the agricultural product 52 into the air flow 56. For example, as each meter 54 rotates, the meter 54 transfers the agricultural product through an opening in the metering system 32 into the respective primary line 38. The agricultural product then mixes with air from the air source 34, thereby forming an air/agricultural product mixture 68. The mixture then flows to the respective row unit(s) 18 of the agricultural seeding implement, where the flowable agricultural product (e.g., seed and/or fertilizer) is deposited within the soil.

In the illustrated embodiment, each primary line 38 is coupled to a respective distribution header 42, and three secondary lines 40 extend from each distribution header 42 to three respective row units 18. Accordingly, the primary lines 38, the distribution headers 42, and the secondary lines 40 direct the air/agricultural product mixture 68 to the row units 18. While the distribution lines 30 include three secondary lines 40 extending from each distribution header 42 in the illustrated embodiment, in other embodiments, the distribution lines may include more or fewer secondary lines extending from each distribution header to respective row unit(s). Furthermore, in certain embodiments, a secondary distribution header may be coupled to at least one secondary line, and tertiary lines may extend from the secondary distribution header to respective row units. In addition, in certain embodiments, at least one distribution header and the secondary lines extending from the at least one distribution header may be omitted. In such embodiments, each respective primary line may extend directly to a respective row unit.

In the illustrated embodiment, each primary line 38 is configured to receive agricultural product from all three storage tanks 28. Accordingly, the agricultural product from the storage tanks mixes within the primary lines (e.g., while all of the meters are rotating). In certain embodiments, the distribution lines may include multiple sets of primary lines (e.g., in which a first set of primary lines receives agricultural product from one or more first storage tanks, and a second set of primary lines receives agricultural product from one or more second storage tanks). In such embodiments, a distribution header may be coupled to each primary line, and secondary lines may extend from each distribution header. In addition, each row unit may be configured to receive agricultural product from multiple secondary lines (e.g., one secondary line for each set of primary lines).

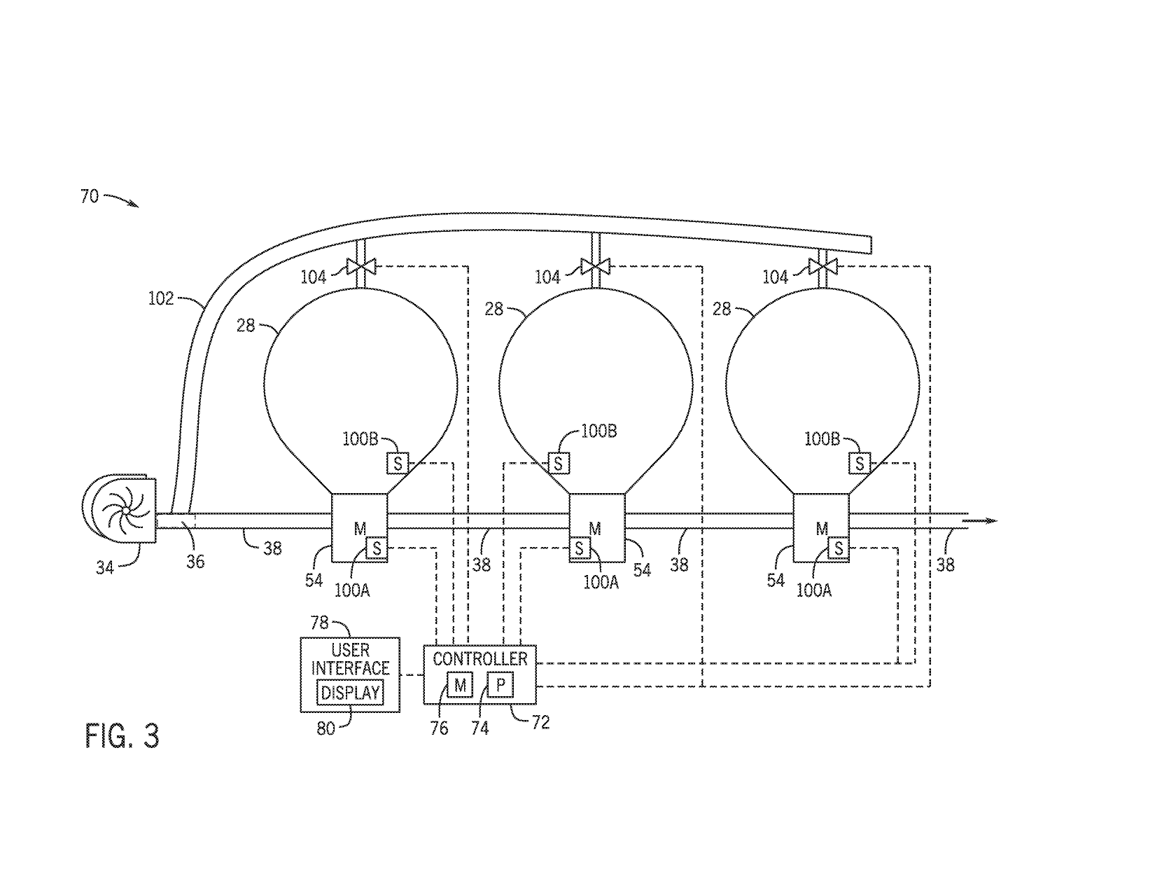

FIG. 3 is a schematic diagram of an embodiment of a tank pressure control system 70 that may be employed within the agricultural product distribution system of FIG. 2. In the illustrated embodiment, the tank pressure control system 70 includes meter pressure sensors 100A and tank pressure sensors 100B. The air source 34 outputs an air flow through the primary lines 38 and a tank pressurization line 102. In the illustrated embodiment, the tank pressurization line 102 extends from the plenum 36. The flow of air from the air source 34 through each primary line 38 flows through respective meters 54, thereby driving the agricultural product from the respective meters 54 to respective row units 18. The flow of air from the air source 34 also pressurizes the storage tanks 28 via air flow through the tank pressurization line 102. The air source 34 may include one or more blowers, fans, air pumps, or the like.

A pressure valve 104 is disposed between each storage tank 28 and the pressurization line 102. Each pressure valve 104 may open to enable air flow into the respective storage tank 28, thereby pressurizing the respective storage tank 28. To control the air pressure within each storage tank 28, the respective pressure valve 104 may open fully, open partially, or close. When the air cart is in use, air flow from the storage tanks 28 causes the pressure within the storage tanks 28 to decrease. Accordingly, the pressure valves 104 may be controlled to establish a desired pressure within the storage tanks 28. For example, the storage tanks 28 may be pressurized such that a static pressure in each storage tank 28 is greater than a static pressure in the respective meters 54, thereby facilitating an even flow of the agricultural product through the respective meters 54. In the illustrated embodiment, the tank pressure control system 70 includes a controller 72 communicatively coupled to each meter pressure sensor 100A and each tank pressure sensor 100B. In certain embodiments, the controller 72 is an electronic controller having electrical circuitry configured to receive a respective sensor signal from each meter pressure sensor 100A and each tank pressure sensor 100B. In the illustrated embodiment, the controller 72 includes a processor 74, such as the illustrated microprocessor, and a memory device 76. The controller 72 may also include one or more storage devices and/or other suitable components. The processor 74 may be used to execute software, such as software for controlling the pressure within the storage tanks 28, and so forth. Moreover, the processor 74 may include multiple microprocessors, one or more “general-purpose” microprocessors, one or more special-purpose microprocessors, and/or one or more application specific integrated circuits (ASICs), or some combination thereof. For example, the processor 74 may include one or more reduced instruction set (RISC) processors.

The memory device 76 may include a volatile memory, such as random access memory (RAM), and/or a nonvolatile memory, such as read-only memory (ROM). The memory device 76 may store a variety of information and may be used for various purposes. For example, the memory device 76 may store processor-executable instructions (e.g., firmware or software) for the processor 74 to execute, such as instructions for controlling the pressure within the storage tanks 28, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the pressure within the storage tanks 28, etc.), and any other suitable data. The controller may be positioned at any suitable location(s) on the agricultural system (e.g., on the air cart and/or on the agricultural seeding implement) and/or on the work vehicle coupled to the agricultural system (e.g., as one element in one location or as multiple elements in multiple locations).

In the illustrated embodiment, the tank pressure control system 70 includes a user interface 78 communicatively coupled to the controller 72. The user interface 78 is configured to receive input from an operator and to provide information to the operator. The user interface 78 may include any suitable input device(s) for receiving input, such as a keyboard, a mouse, button(s), switch(es), knob(s), other suitable input device(s), or a combination thereof. In addition, the user interface 78 may include any suitable output device(s) for presenting information to the operator, such as speaker(s), indicator light(s), other suitable output device(s), or a combination thereof. In the illustrated embodiment, the user interface 78 includes a display 80 configured to present visual information to the operator. In certain embodiments, the display 80 may include a touchscreen interface configured to receive input from the operator.

Each meter pressure sensor 100A is fluidly coupled to a respective meter 54, and each meter pressure sensor 100A is configured to output a respective sensor signal (e.g., meter pressure signal) indicative of the air pressure within the respective meter 54 (e.g., which may be equal to the air pressure within the respective primary line at the respective meter). Each meter pressure sensor 100A may include any suitable type(s) of pressure monitoring device(s), such as a piezo electric pressure sensor, a capacitive pressure sensor, an electromagnetic pressure sensor, other suitable type(s) of pressure monitoring device(s), or a combination thereof. In certain embodiments, for each storage tank 28, a meter pressure sensor 100A may be fluidly coupled to one meter 54. Accordingly, for each storage tank 28, the controller 72 may determine a respective meter pressure based on feedback from the one meter pressure sensor 100A. Furthermore, in certain embodiments, for each storage tank 28, a meter pressure sensor 100A may be fluidly coupled to each meter 54. Accordingly, for each storage tank 28, the controller may determine a respective meter pressure based on feedback from multiple pressure sensors 100A (e.g., by averaging the monitored pressures at each meter coupled to the storage tank).

Each tank pressure sensor 100B is fluidly coupled to a respective storage tank 28. In addition, each tank pressure sensor 100B is configured to output a respective sensor signal (e.g., tank pressure signal) indicative of the air pressure within the respective storage tank 28. Each tank pressure sensor 100B may include any suitable type(s) of pressure monitoring device(s), such as a piezo electric pressure sensor, a capacitive pressure sensor, an electromagnetic pressure sensor, other suitable type(s) of pressure monitoring device(s), or a combination thereof.

As illustrated, each pressure valve 104 is communicatively coupled to the controller 72. In certain embodiments, each pressure valve 104 includes an actuator configured to control a position of the valve (e.g., between the fully open position and the closed position), and the actuator is communicatively coupled to the controller 72. The controller 72 is configured to receive the sensors signals from the tank pressure sensor 100B and the meter pressure sensor(s) 100A for each storage tank 28. In addition, the controller 72 is configured to control the pressure valves 104 based on the meter pressures and the tank pressures.

In some embodiments, the controller 72 of the tank pressure control system 70 may adjust the pressure valves 104 in anticipation of a decrease in storage tank pressure associated with initiation of agricultural product flow through the meters 54 or a change in meter rotation rate. For example, initiation of flow of agricultural product through a meter 54 may decrease the pressure in the respective storage tank 28. Further, an automated system may control the meters in response to the agricultural system reaching a certain section of the field (e.g., the automated system may control the meters to deposit more or less agricultural product by altering the meter rotation rates). As such, the tank pressure control system 70 may preemptively adjust the pressure valve 104 for each storage tank 28 in anticipation of a change in meter operation. For example, as the meters initiate dispensing the agricultural product, the pressure in the storage tanks 28 may decrease. To counter the anticipated decrease in differential pressure, the tank pressure control system 70 may preemptively increase the opening of the pressure valves 104 to mitigate the anticipated increase in meter pressure, thereby maintaining the current pressure differentials within the target pressure differential range.

The controller 72 of the tank pressure control system 70 may determine a respective meter pressure for each meter 54 of the multiple meters 54 based on the respective meter pressure signal and a respective tank pressure for each storage tank 28 of the multiple storage tanks 28 based on the respective tank pressure signal. The controller 72 may then determine a respective current pressure differential for each storage tank 28 of the multiple storage tanks 28 based on the respective meter pressure and the respective storage tank pressure. For each storage tank 28 of the multiple storage tanks 28, the controller 72 may compare the respective current pressure differential to a target pressure differential range, which may be based on a minimum pressure threshold and a maximum pressure threshold. For each storage tank 28 of the multiple storage tanks 28, the controller 72 may adjust a respective pressure valve 104 of the plurality of pressure valves 104 based on the comparison of the respective current pressure differential to the target pressure differential range. In response to determining the respective current pressure differential for any storage tank 28 of the multiple storage tanks 28 is less than the minimum pressure threshold while the respective pressure valve 104 is fully open, the controller 72 may reduce the maximum pressure threshold. The new pressure differential threshold range may cause the controller to adjust the pressure valves 104 for the other storage tanks 28, such that the respective current pressure differentials are within the new target pressure differential range, which has a lower maximum pressure threshold. As a result, more pressure may be available to pressurize the storage tank in which the respective valve is fully open, such that the current pressure differential for the storage tank is within the new target pressure differential range. Accordingly, the metering system may more accurately and uniformly meter the agricultural product, thereby enhancing crop yield.

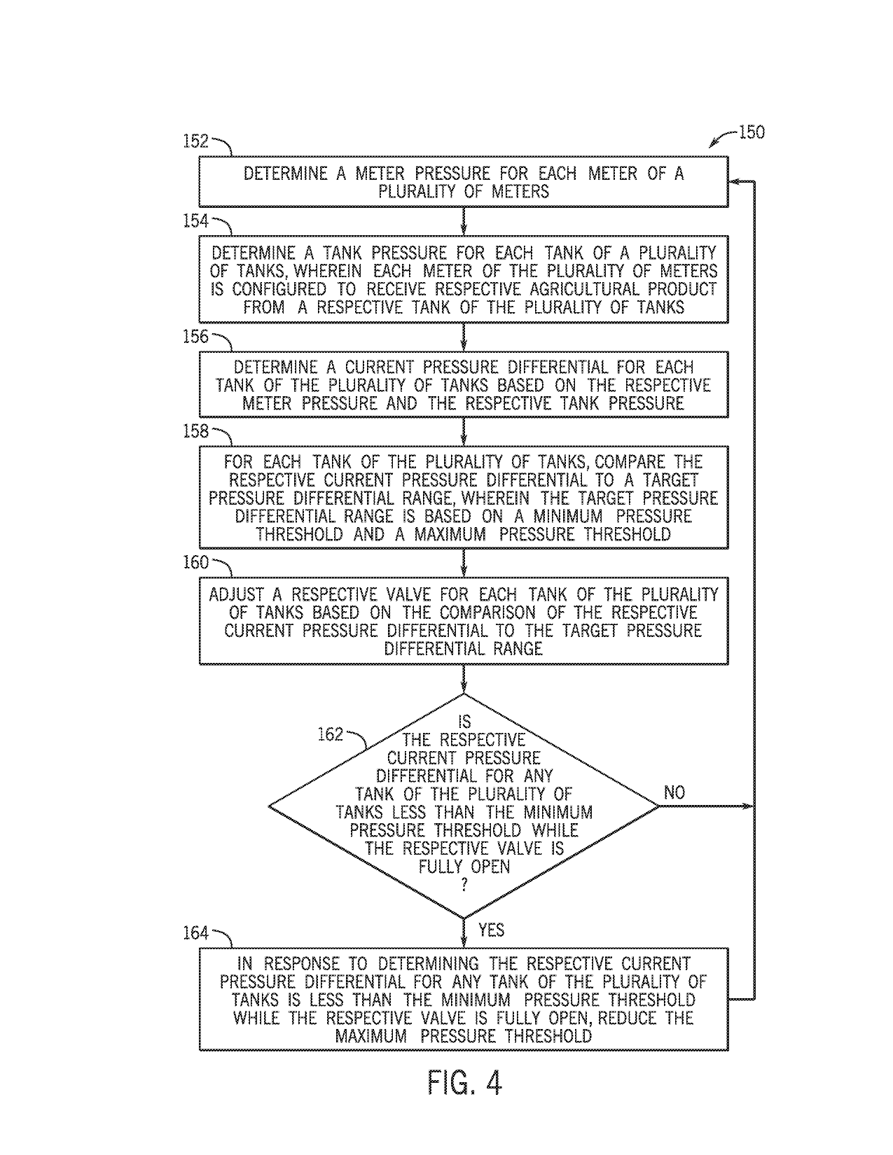

FIG. 4 is a flow chart of an embodiment of a method 150 of operating a tank pressure control system. The steps of the method 150 may be performed in the order disclosed below or in any other suitable order. In addition, in certain embodiments, one or more steps of the method 150 may be omitted, and/or the method may include one or more additional steps. The method 150 may be performed by the controller disclosed above with reference to FIG. 3, by one or more other suitable controllers, or a combination thereof.

At block 152, a meter pressure for each meter (e.g., each monitored meter) is determined. The meter pressure for each meter may be determined based on feedback from a respective meter pressure sensor (e.g., based on a respective meter pressure signal). At block 154, a tank pressure for each storage tank is determined. The tank pressure for each storage tank may be determined based on feedback from a respective tank pressure sensor (e.g., based on a respective tank pressure signal). As previously discussed, each meter is configured to receive respective agricultural product from a respective storage tank. The step at block 154 of the method 150 may occur concurrently with or in sequence with the step at block 152.

When both the meter pressure and the tank pressure for each storage tank are determined, at block 156, a current pressure differential for each storage tank is determined. Each current pressure differential is based on the respective meter pressure and the respective tank pressure for the respective storage tank. For example, in certain embodiments, the current pressure differential is equal to the respective tank pressure minus the respective meter pressure.

Once the current pressure differential for each storage tank is determined, for each storage tank, the respective current pressure differential is compared to a target pressure differential range, at block 158. The target pressure differential range is based on a minimum pressure threshold and a maximum pressure threshold. For example, the target pressure differential range may extend between the minimum pressure threshold and the maximum pressure threshold, exclusive of the minimum pressure threshold and the maximum pressure threshold. The minimum pressure threshold and the maximum pressure threshold may be selected based on a desired pressure differential for the storage tanks. In certain embodiments, the desired pressure differential for the storage tanks may be determined based on factors such as the size of the storage tanks, the target flow rate of the agricultural product through the respective meters, the remaining amount of agricultural product within the storage tanks, and the like. For example, a higher target pressure differential range may be selected for a heavier agricultural product through the respective storage tanks, and a lower target pressure differential range may be selected for a lighter agricultural product within the storage tanks.

The target pressure differential threshold range may be based on the desired metered flow rate. Further, when the tank pressure control system maintains the pressure differential for each storage tank within the target pressure differential threshold range, the accuracy of the metering system may increase. As a result, the metering system may more accurately establish the target agricultural product flow rate through each meter (e.g., as compared to the pressure differential being greater than the maximum pressure threshold, which may result in a flow rate of agricultural product into the primary lines being higher than the target agricultural product flow rate, and as compared to the current pressure differential being less than the minimum pressure threshold, which may result in a flow rate of agricultural product into the primary lines being lower than the target agricultural product flow rate).

In certain embodiments, a user may manually input the minimum pressure threshold and the maximum pressure threshold via the user interface (e.g., based on user experience with the agricultural system). For example, the user may determine over many seeding operations that utilizing a certain minimum pressure threshold and a certain maximum pressure threshold may cause the agricultural system to operate effectively.

If the current pressure differential for a respective storage tank is greater than the maximum pressure threshold, the current pressure differential is above the target pressure threshold range. If the current pressure differential is above the target pressure threshold range, the flow rate of agricultural product from the respective storage tank may be greater than a target flow rate because excess pressure within the respective storage tank may force more agricultural product from the respective storage tank than is metered by the respective meter(s). As a result, the amount of agricultural product output by the row units fluidly coupled to the respective storage tank may be greater than desired, which may reduce crop yield due to overcrowding the field.

If the current pressure differential for a respective storage tank is greater than or equal to the minimum pressure threshold and less than or equal to the maximum pressure threshold, the current pressure differential (e.g., the storage tank pressure minus the meter pressure) is within the target pressure threshold range. When the current pressure differential is within the pressure threshold range, the respective meter(s) may accurately meter agricultural product from the respective storage tank to the respective primary line(s).

If the current pressure differential for a respective storage tank is less than the minimum pressure threshold, the current pressure differential (e.g., the storage tank pressure minus the meter pressure) is below the target pressure threshold range. If the current pressure differential is below the target pressure threshold range, the flow rate of agricultural product from the respective storage tank may be less than a target flow rate because insufficient pressure within the respective storage tank may cause less agricultural product to enter the respective meter(s), thus reducing the flow rate of the agricultural product from the respective meter(s). As a result, the amount of agricultural product output by the row units fluidly coupled to the respective storage tank may be less than desired, which may reduce crop yield due to under seeding the field.

After the current pressure differential is compared to the target pressure differential range for each storage tank, at block 160, a respective pressure valve is adjusted for each storage tank based on the comparison. If the current pressure differential (e.g., the storage tank pressure minus the meter pressure) for a respective storage tank is within the pressure threshold range, the respective pressure valve is adjusted by maintaining the opening of the respective pressure valve (e.g., not moving the position of the respective pressure valve toward the fully open position or toward the closed position).

If the current pressure differential (e.g., the storage tank pressure minus the meter pressure) for a respective storage tank is greater than the maximum pressure threshold, the respective pressure valve is adjusted (e.g., via the respective actuator) by decreasing opening of the respective pressure valve (e.g., moving the position of the respective pressure valve toward the closed position or to the closed position). For example, when the current pressure differential is significantly above the maximum pressure threshold and/or a rapid pressure change is desired, the respective pressure valve may be moved to the closed position. Alternatively, the respective pressure valve may be moved toward the closed position, thereby reducing the pressure differential.

If the current pressure differential (e.g., the storage tank pressure minus the meter pressure) for a respective storage tank is less than the minimum pressure threshold, the respective pressure valve is adjusted (e.g., via the respective actuator) by increasing opening of the respective pressure valve (e.g., moving the position of the respective pressure valve toward the fully open position or to the fully open position). For example, when the current pressure differential is significantly below the minimum pressure threshold and/or a rapid pressure change is desired, the respective pressure valve may be moved to the fully open position. Alternatively, the respective pressure valve may be moved toward the fully open position, thereby increasing the pressure differential.

Once the respective valves are adjusted, at block 162, a determination is made regarding whether the respective current pressure differential for any storage tank is less than the minimum pressure threshold while the respective valve is fully open. If the respective current pressure differential for any storage tank is greater than or equal to the minimum pressure threshold while the respective valve is fully open, the method 150 returns to block 152 to repeat the process. Conversely, if the respective current pressure differential for any storage tank is less than the minimum pressure threshold while the respective valve is fully open, the method 150 continues to block 164.

At block 164, in response to determining the respective current pressure differential for any storage tank is less than the minimum pressure threshold while the respective valve is fully open, the maximum pressure threshold is reduced. In certain embodiments, the maximum pressure threshold is reduced toward the minimum pressure threshold by a fixed increment. The fixed increment may be selected based on the configuration of the agricultural system, the type (e.g., density, size, weight, etc.) of agricultural product, and the like. Furthermore, the user may manually enter the fixed increment via the user interface. In certain embodiments, a pressure reduction increment may be determined based on a difference between the minimum pressure threshold and the respective current pressure differential that is less than the minimum pressure threshold. In such embodiments, the maximum pressure threshold is reduced by the pressure reduction increment.

The method 150 is performed iteratively. Therefore, once the step at block 162 or block 164 is complete, depending on the response at block 162, the method 150 loops back to the first block 152 to repeat the method 150. Accordingly, by decreasing the maximum pressure threshold at block 164, one or more pressure valves may be moved toward the closed position during the subsequent loop because the respective current pressure differential(s) are no longer within the target pressure differential range for the respective storage tank(s). Moving the pressure valve(s) toward the closed position reduces the tank pressure(s), thereby providing additional air pressure within the tank pressurization line for the storage tank(s) at which the current pressure differential is less than the minimum pressure threshold and the respective valve(s) are fully open. As a result, the current pressure differential for the storage tank(s) at which the current pressure differential is less than the minimum pressure threshold and the respective valve(s) are fully open may be within the target pressure differential range. Otherwise, the maximum pressure threshold may be further reduced as the method 150 continues through the step at block 164. Accordingly, for each storage tank, the current pressure differential may be greater than or equal to the minimum threshold pressure.

In certain embodiments, the user is notified of the maximum pressure threshold adjustment, the valve adjustment, or both. The notification may appear on the display of the user interface. The notification may include a report on which storage tank(s) are associated with current pressure differential(s) that are outside the target pressure differential range, the relevant pressure measurement(s), and the like. Further, in some embodiments, the user may be able to override the maximum pressure threshold adjustment, the valve adjustment, or both. The notification may include an option for the user to approve or disapprove the maximum pressure threshold adjustment, and/or an option to override an automatic maximum pressure threshold adjustment (e.g., and revert to the original target pressure differential range).

In some embodiments, the target pressure differential range may be reset (e.g., automatically or manually) when the storage tanks are refilled with agricultural product. For example, when the storage tanks are opened to refill the agricultural product, the storage tanks may completely depressurize, thereby providing an opportunity to reset the target pressure differential range. Further, the target pressure differential range may be reset (e.g., automatically or manually) any time the storage tanks are completely depressurized.

In the embodiments disclosed above, the target pressure differential range is the same for all storage tanks. However, in certain embodiments, the target pressure differential range may be different for each storage tank of the multiple storage tanks. In embodiments in which the target pressure differential range is different for each storage tank, the comparing step is based on the respective target pressure differential range, which is based on respective minimum and maximum pressure thresholds for each respective storage tank. The adjustment may be based on the respective comparison between the respective minimum and maximum pressure thresholds for each respective storage tank. In response to determining the respective current pressure differential for any storage tank of the multiple storage tanks is less than the respective minimum pressure threshold while the respective pressure valve is fully open, the maximum pressure threshold for each storage tank may be reduced.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function)…” or “step for (perform)ing (a function)…”, it is intended that such elements are to be interpreted under 35 U.S.C. 112(f). However, for any claims containing elements designated in any other manner, it is intended that such elements are not to be interpreted under 35 U.S.C. 112(f).

1. A control system for an agricultural seeding implement, comprising:
a controller comprising a memory and a processor, wherein the controller is configured to iteratively:
determine a respective meter pressure for each meter of a plurality of meters;
determine a respective tank pressure for each storage tank of a plurality of storage tanks, wherein each meter of the plurality of meters is configured to receive respective agricultural product from a respective storage tank of the plurality of storage tanks;
determine a respective current pressure differential for each storage tank of the plurality of storage tanks based on the respective meter pressure and the respective tank pressure;
for each storage tank of the plurality of storage tanks, compare the respective current pressure differential to a target pressure differential range, wherein the target pressure differential range is based on a minimum pressure threshold and a maximum pressure threshold;
adjust a respective pressure valve for each storage tank of the plurality of storage tanks based on the comparison of the respective current pressure differential to the target pressure differential range; and
in response to determining the respective current pressure differential for any storage tank of the plurality of storage tanks is less than the minimum pressure threshold while the respective pressure valve is fully open, reduce the maximum pressure threshold.

2. The control system of claim 1, wherein the controller is configured to determine a pressure reduction increment based on a difference between the minimum pressure threshold and the respective current pressure differential that is less than the minimum pressure threshold, and the controller is configured to reduce the maximum pressure threshold by reducing the maximum pressure threshold by the pressure reduction increment.

3. The control system of claim 1, wherein the controller is configured to reduce the maximum pressure threshold by reducing the maximum pressure threshold by a fixed increment.

4. The control system of claim 1, wherein the controller is configured to adjust the respective pressure valve by decreasing opening of the respective pressure valve in response to determining the respective current pressure differential is greater than the maximum pressure threshold.

5. The control system of claim 1, wherein the controller is configured to adjust the respective pressure valve by increasing opening of the respective pressure valve in response to determining the respective current pressure differential is less than the minimum pressure threshold.

6. The control system of claim 1, wherein the controller is configured to adjust the respective pressure valve by maintaining opening of the respective pressure valve in response to determining the respective current pressure differential is greater than or equal to the minimum pressure threshold and less than or equal to the maximum pressure threshold.

7. An agricultural seeding implement, comprising:
a plurality of storage tanks;
a plurality of meters, wherein each meter of the plurality of meters is configured to receive respective agricultural product from a respective storage tank of the plurality of storage tanks;
a plurality of pressure valves coupled to the plurality of storage tanks, wherein each pressure valve of the plurality of pressure valves is configured to control pressure within a respective storage tank of the plurality of storage tanks; and
a control system comprising:
a plurality of tank pressure sensors each configured to output a respective tank pressure signal indicative of the pressure within a respective tank of the plurality of tanks;
a plurality of meter pressure sensors each configured to output a respective meter pressure signal indicative of a pressure within a respective meter of the plurality of meters; and
a controller having a memory and a processor, wherein the controller is communicatively coupled to the plurality of pressure valves, to the plurality of tank pressure sensors, and to the plurality of meter pressure sensors, and the controller is configured to iteratively:
determine a respective meter pressure for each meter of the plurality of meters based on the respective meter pressure signal;
determine a respective tank pressure for each storage tank of the plurality of storage tanks based on the respective tank pressure signal;
determine a respective current pressure differential for each storage tank of the plurality of storage tanks based on the respective meter pressure and the respective tank pressure;
for each storage tank of the plurality of storage tanks, compare the respective current pressure differential to a target pressure differential range, wherein the target pressure differential range is based on a minimum pressure threshold and a maximum pressure threshold;
for each storage tank of the plurality of storage tanks, adjust a respective pressure valve of the plurality of pressure valves based on the comparison of the respective current pressure differential to the target pressure differential range; and
in response to determining the respective current pressure differential for any storage tank of the plurality of storage tanks is less than the minimum pressure threshold while the respective pressure valve is fully open, reduce the maximum pressure threshold.

8. The agricultural seeding implement of claim 7, wherein the controller is configured to determine a pressure reduction increment based on a difference between the minimum pressure threshold and the respective current pressure differential that is less than the minimum pressure threshold, and the controller is configured to reduce the maximum pressure threshold by reducing the maximum pressure threshold by the pressure reduction increment.

9. The agricultural seeding implement of claim 7, wherein the controller is configured to reduce the maximum pressure threshold by reducing the maximum pressure threshold by a fixed increment.

10. The agricultural seeding implement of claim 7, wherein the controller is configured to adjust the respective pressure valve by increasing opening of the respective pressure valve in response to determining the respective current pressure differential is less than the minimum pressure threshold.

11. The agricultural seeding implement of claim 7, wherein the controller is configured to adjust the respective pressure valve by decreasing opening of the respective pressure valve in response to determining the respective current pressure differential is greater than the maximum pressure threshold.

12. The agricultural seeding implement of claim 7, wherein the controller is configured to adjust the respective pressure valve by maintaining opening of the respective pressure valve in response to determining the respective current pressure differential is greater than or equal to the minimum pressure threshold and less than or equal to the maximum pressure threshold.

13. The agricultural seeding implement of claim 8, wherein the controller, for each storage tank of the plurality of storage tanks, is configured to adjust the respective pressure valve based on an anticipated initiation of a respective meter of the plurality of meters, an anticipated change in meter rotation rate of the respective meter, or a combination thereof.

14. A method for controlling storage tank pressurization within an agricultural seeding implement, comprising iteratively:
determining, via a controller comprising a processor and a memory, a respective meter pressure for each meter of a plurality of meters;
determining, via the controller, a respective tank pressure for each storage tank of a plurality of storage tanks, wherein each meter of the plurality of meters is configured to receive respective agricultural product from a respective storage tank of the plurality of storage tanks;
determining, via the controller, a respective current pressure differential for each storage tank of the plurality of storage tanks based on the respective meter pressure and the respective tank pressure;
for each storage tank of the plurality of storage tanks, comparing, via the controller, the respective current pressure differential to a target pressure differential range, wherein the target pressure differential range is based on a minimum pressure threshold and a maximum pressure threshold;
adjusting, via the controller, a respective pressure valve for each storage tank of the plurality of storage tanks based on the comparison of the respective current pressure differential to the target pressure differential range; and
in response to determining the respective current pressure differential for any storage tank of the plurality of tanks is less than the minimum pressure threshold while the respective pressure valve is fully open, reducing, via the controller, the maximum pressure threshold.

15. The method of claim 14, comprising determining, via the controller, a pressure reducing increment based on a difference between the minimum pressure threshold and the respective current pressure differential that is less than the minimum pressure threshold, wherein reducing the maximum pressure threshold comprises reducing the maximum pressure threshold by a pressure reduction increment.

16. The method of claim 14, wherein reducing the maximum pressure threshold comprises reducing the maximum pressure threshold by a fixed increment.

17. The method of claim 14, comprising, for each storage tank of the plurality of storage tanks, adjusting the respective pressure valve based on an anticipated initiation of a respective meter of the plurality of meters, an anticipated change in meter rotation rate of the respective meter, or a combination thereof.

18. The method of claim 14, wherein adjusting the respective pressure valve comprises decreasing opening of the respective pressure valve in response to determining the respective current pressure differential is greater than the maximum pressure threshold.

19. The method of claim 14, wherein adjusting the respective pressure valve comprises increasing opening of the respective pressure valve in response to determining the respective current pressure differential is less than the minimum pressure threshold.

20. The method of claim 14, wherein adjusting the respective pressure valve comprises maintaining opening of the respective pressure valve in response to determining the respective current pressure differential is greater than or equal to the minimum pressure threshold and less than or equal to the maximum pressure threshold.
